(19) United States
(12) Patent Application Publication
(10) Pub. No.: US 2026/0135211 A1
(43) Pub. Date: May 14, 2026

(54) Cell of An Energy Storage Device

(71) Applicant: Dstem LLC, Phoenix, AZ (US)

(72) Inventors: Jun Li, Phoenix, AZ (US); Zhenlian Chen, Wuhan (CN)

(21) Appl. No.: 19/434,389

(22) Filed: Dec. 29, 2025

Related U.S. Application Data
(60) Provisional application No. 63/530,181, filed on Aug. 1, 2023.
(60) Provisional application No. 63/739,679, filed on Dec. 30, 2024.

(51) Int. Cl. H01M 50/179; H01G 11/04; H01G 11/28; H01G 11/56; H01G 11/58; H01G 11/78; H01G 11/84; H01M 10/052; H01M 10/0587; H01M 50/107; H01M 50/152; H01M 50/169; H01M 50/533; H01M 50/536

(52) U.S. Cl. CPC H01M 50/179; H01G 11/28; H01G 11/56; H01G 11/58; H01G 11/78; H01G 11/84; H01M 10/052; H01M 10/0587; H01M 50/107; H01M 50/152; H01M 50/169; H01M 50/533; H01M 50/536; H01G 11/04

(57) ABSTRACT

The present invention discloses an energy storage device cell that features an electrode assembly on a central shaft. This entire assembly is enclosed within a casing that includes a cover and a bottom, which function as the two opposite external terminals. The electrode assembly consists of two electrode plates, each with tabs, separated by interposed separators. The shaft runs through the electrode assembly, protruding from both the cover and the bottom, establishing a channel of convective flowpathway. Disclosed herein is the shaft in combination with the welded ties that connect the two opposite sets of electrode tabs, integrating electrical and thermal conductivities simultaneously into the cell structure.

### INCORPORATION BY REFERENCE TO ANY PRIORITY APPLICATIONS

Any and all applications for which a foreign or domestic priority claim is identified in the Application Data Sheet or Request as filed with the present application are hereby incorporated by reference under 37 CPR 1.57, and Rules 4.18 and 20.6, such as “hollow column cell and methods of manufacturing thereof”, U.S. Provisional App. No. 63/530,181, filed Aug. 1, 2023, and “shaft cell and methods of manufacturing thereof”, U.S. Provisional App. No. 63/739,679, filed Dec. 30, 2024.

### BACKGROUND OF THE INVENTION

### Field of the Invention

The present invention relates to the field of energy storage devices. Specifically, it involves a cell structure or cell form with a built-in thermal conducting channel for electrochemical and electrophysical systems.

### Description of Related Art

As battery electric vehicle (BEV) and battery energy storage stations (BESS) have been increasingly developed, the demand for batteries has also sharply increased as an energy source for electrical transportation and electrical power for utility-grade or mobile energy storage solutions. Accordingly, much research and development on cells and batteries of energy storage devices and methods of manufacturing thereof has been carried out to satisfy various needs.

For the cells of BEV and BESS, thermal management is as critical as their functionality of electrical energy storage. Inappropriate thermal monitor and control can result in thermal runaway in such as a lithium-ion battery, which is one of the primary concerns of safety in general in BEV and BESS. Due to the intrinsic limitation of electrical conductivities at low temperature for both active cathode and anode materials and electrolytes, the BEV needs to pre-heat to make the charging more effective and safer in winter. Altitude changes limit the reaching of typical pouch cells in aircraft and submarine due to gassing in operations. The utility-scale regulation requires BESS 15-minute fast response to random, unpredictable variations in demand and generation. Study shows that charging at elevated temperature may boost the fast charging, typically in 15 minutes from discharged state to 80% of SOC, which offers a practical solution to the range anxiety of BEV, especially in coupling with the high-power supercharging stations.

However, the state-of-the-art secondary cell and battery, such as a lithium-ion battery, sodium-ion battery, and supercapacitor, no matter what cell structures or cell forms are adopted in cylindrical, prismatic, or pouch cells, cannot meet the effective thermal requirement at the cell level to mitigate the thermal runaway risks and to boost the electrical performance as needed. The design of battery management system is insufficient while costly to boost the fast-charging capability and to stop the thermal runaway timely.

Concepts of cell to pack or cell to chassel intend to integrate the cells as a ready structural component with thermal management. However, system efficiency is largely limited by the available surface area of the cells in use, e.g., inefficient heat dissipation in the base and side of the cylindrical cells. Typically, the electrode foils and two separator films are wound around a winding mandrel for prismatic cells or a center pin for cylindrical cells. The hottest inner electrodes cannot conduct efficiently the thermal exchange directly with the external controlling heating, ventilation, and air conditioning (HVAC) system. That limits the effectiveness of the electrical and thermal exchanges between the inner portion of the cell electrodes and external thermal management devices. Furthermore, the welding of electrode tabs with the external terminals in either prismatic or cylindrical cells is costly, being one of the major bottlenecks of the high yield massive production.

The traditional configuration of electrode stacking, either typical Z-folding stacks in pouch cells or jelly rolls in prismatic and cylindrical cells, creates a temperature difference and heat distortion from the inner electrodes to external tab terminals. That makes it difficult to effectively sense and regulate the thermal uniformity at the cell levels. Without direct physical connection, algorithms within artificial intelligence cannot effectively and efficiently catch and learn the latent development of thermal runaway and health degradation of the cells in applications.

### SUMMARY OF THE INVENTION

The present invention has been made to solve the above problems. As a result of variety of extensive and intensive studies and experiments to solve the problems as described above, the inventors of the present invention have found that, a shaft, either a solid bar or a conducting tube, protruding through the body of the electrode assembly, can transport effectively and efficiently the heat flow from inside of the cells to an external system or the environment. This cell structure or form provides advantages in cell manufacturing, synchronization of thermal and electrical controls, and pack frames. The present invention has been completely based on these findings.

The present invention aims to propose a cell structure of an energy storage device, the cell comprising: an electrode assembly comprising two electrode plates with tabs and a separator interposed between the plates; a shaft comprising a body, a head, and a tail, the body supports the electrode assembly, the head connects one set of tabs of the electrode assembly, and the tail connects the other opposite set of tabs of the electrode assembly; and an enclosure comprising a cover, a bottom, and a thin-walled shell, the enclosure encloses the electrode assembly inside, the cover and the bottom are two opposite external terminals, respectively, and the shaft runs through the electrode assembly and protrudes from the cover and the bottom of the enclosure, and the head and the tail parts connect with the cover and the bottom, respectively. This cell structure is easily scalable to a big form used as structural modules and/or frames of electric vehicles, electric vertical take-off and landing aircrafts, electric powered ships, grid and/or mobile energy storage stations, as well as a ready adoptive device within the art of distributed battery management system and artificial intelligence to synchronize the cell electrical performance with thermal management, especially implementable in closed systems for all weather, all terrain operations.

According to one embodiment of the present invention, each electrode plate consists of a current collector comprising an active area overlapping in the electrode assembly and a tab area non-overlapping in the electrode assembly, the tab comprises an intermittent pattern in the machine direction, and one electrode plate forms an anode, and the other electrode plate forms a cathode.

According to one embodiment of the present invention, the separator is made of an electrically insulating ion-conductive medium, and the electrical insulating ionic conducting medium is a solid-state electrolyte, or a polymer electrolyte, or a polymeric ionic liquid electrolyte, or a hybrid electrolyte system.

According to one embodiment of the present invention, the hybrid electrolyte system is a mixture of solid-state electrolyte with liquid electrolyte or a polymer electrolyte with liquid electrolyte or a polymer film soaked with liquid electrolyte.

According to one embodiment of the present invention, the polymer film is coated with ceramic and salts, the liquid electrolyte is a non-aqueous organic electrolyte or aqueous electrolyte or ionic liquid electrolyte, and the solid-state electrolyte comprises flexible fibers infused with fast ionic conductive solids.

According to one embodiment of the present invention, the body of the shaft consists of a solid bar comprising electrically and thermally conductive materials of metal, metal alloy, compounds, metallized plastic composites, or one or a mixture of them, the bar is in any shape selected from a group consisting of circular, triangular, square, elliptical and rectangular shapes, and the bar conducts electrical current and heat flow from one end to the other end of the shaft.

According to one embodiment of the present invention, the body of the shaft consists of a conducting tube comprising electrically and thermally conductive materials of metal, metal alloy, compounds, metallized plastic composites, or one or a mixture of them, the cross section of the conducting tube is in any shape selected from a group consisting of circular, triangular, square, elliptical and rectangular shapes, the conducting tube conducts electrical current and liquid or gaseous flows from one end to the other end of the shaft, and the inner wall of the conducting tube may or may not contain an inward dent design to vent gases in case of thermal runaway or explosion.

According to one embodiment of the present invention, the head of the shaft consists of a rim on one end of the body and a tie connected with one folded tab of one electrode plate, the rim is a protrusion of the body, the tie is the contact point to the tab of one electrode plate, one end of the body may protrude from the rim, and the rim and the tie are electrically and thermally conductive materials of metal, metal alloy, compounds, metallized plastic composites, or one or a mixture of them.

According to one embodiment of the present invention, the tail of the shaft consists of an insulating tube on the other end of the body and a tie connected with the folded tab of the other electrode plate, the tube insulates the tie from the body, the other end of the body may protrude from the tail, and the tie is an electrically and thermally conductive material of metal, metal alloy, compounds, metallized plastic composites, or one or a mixture of them.

According to one embodiment of the present invention, the cover, the bottom, and the thin-walled shell of the enclosure are electrically and thermally conductive materials of metal, metal alloy, compounds, metallized plastic composites, or one or a mixture of them.

According to one embodiment of the present invention, the cover and the bottom of the enclosure comprise an open section to allow the ends of the shaft to protrude through. The cover encloses the shaft head from outside; the bottom encloses the shaft tail from outside. The cover is insulated from the thin-walled shell of the enclosure and is the contact point to the head rim and tie of the shaft, and with the shaft body serving as one terminal of the finished cell; the bottom is insulated from the body of the shaft and is the contact point to the tail tie of the shaft, serving as the other terminal of the finished cell, and the bottom may or may not be insulated from the thin-walled shell.

According to one embodiment of the present invention, the cover comprises a hole or no hole, the cover comprises a dent or no dent, the hole is resealable for liquid electrolyte injection, degassing in formation, and/or regeneration flushing, and the dent is a vent design to release gases and pressure in case of thermal runaway or explosion.

According to one embodiment of the present invention, the bottom comprises a hole or no hole, the bottom comprises a dent or no dent, the hole is resealable for liquid electrolyte injection, degassing in formation, and/or regeneration flushing, the dent is a vent design to release gases and pressure in case of thermal runaway or explosion. The bottom may be an undetachable portion of the enclosure.

According to one embodiment of the present invention, the current collector of the two electrode plates comprises the same electrically and thermally conductive materials of metal foil, metal foam, 3-D conductive substrate, plastic electrodes, metallized plastic composites, or one or a mixture of them.

According to one embodiment of the present invention, the current collector of the two electrode plates comprises different electrically and thermally conductive materials of metal foil, metal foam, 3-D conductive substrate, plastic electrodes, metallized plastic composites, or one or a mixture of them.

According to one embodiment of the present invention, the active area of the electrode plate is coated with electrode materials composites, the active area of the electrode plate is laminated with a separator, the anode and the cathode comprise the same electrode materials composite, the anode and the cathode comprise different electrode materials composites.

According to one embodiment of the present invention, the anode or the cathode comprises current collectors, or metal alloying current collectors, or composited current collectors, or ceramic laminated current collectors, or polymer coating current collectors, or a mixture thereof.

According to one embodiment of the present invention, the cell is a primary or secondary electrochemical cell, or an electrophysical cell, including but not limited to such as a lithium-ion battery, a sodium-ion battery, a lithium-sulfur battery, a lithium-metal anode battery, an all-solid-state battery, a metal-air battery, a symmetric supercapacitor, a nonsymmetric supercapacitor, and other advanced chemistry and physics systems of energy storage devices.

According to one embodiment of the present invention, the body of shaft includes at least one channel or groove along its length to facilitate the flow of liquid or gas, or to provide a pathway for a sensor or a thermal management element.

In addition, the present invention may also provide a method of manufacturing a cell of an energy storage device, the method comprising: providing an electrode assembly comprising two electrode plates with tabs and a separator interposed between the plates; providing a shaft comprising a body, a head, and a tail; supporting the electrode assembly on the body of the shaft; connecting one set of tabs of the electrode assembly to the head of the shaft, and connecting the opposite set of tabs of the electrode assembly to the tail of the shaft; enclosing the electrode assembly and the shaft in an enclosure comprising a cover, a bottom, and a thin-walled shell; wherein the enclosure encloses the electrode assembly inside, the cover and the bottom form two opposite external terminals, and the shaft protrudes from the cover and the bottom, and the head and the tail connect with the cover and the bottom, respectively.

According to one embodiment of the present invention, the method further comprising pressing the shafted electrode assembly into a square, or elliptical or rectangular shapes by cold or hot-pressing hardware before enclosing.

According to one embodiment of the present invention, the method further comprising welding the head tie with one of tabs of the electrode assembly, welding the head rim with the cover from outside, insulting the cover from the thin-walled shell, and clamping the cover with the thin-walled shell.

According to one embodiment of the present invention, the method further comprising welding the tail tie with opposite tabs of the electrode assembly, welding the tail tie with the inner side of the thin-walled shell, insulting the bottom from the shaft body, welding the bottom on the inside of thin-walled shell, and clamping the bottom on the outer side of the shaft tail.

### BRIEF DESCRIPTION OF THE FIGURES

To clarify the technical solutions of the embodiments of the present invention, the following is a brief description of the drawings used in the embodiments. It should be understood that the following drawings illustrate only certain embodiments of the present invention and should not be considered as limiting the scope. Those skilled in the art can derive other relevant drawings based on these illustrations without inventive effort.

FIG. 1A is a schematic diagram of a cell according to an embodiment of the present invention.

FIG. 1B is a bottom view of a cell according to an embodiment of the present invention.

FIG. 1C is a cross-sectional view taken along the line a-a of FIG. 1A according to the present invention.

FIG. 1D is an explosive view of a cell according to an embodiment of the present invention.

FIG. 2A is a schematic diagram of an electrode plate according to an embodiment of the present invention.

FIG. 2B shows a comparative example 1 of a practical design of a tabless electrode plate used in the Tesla 4680-type cylindrical cells.

FIG. 2C is a schematic diagram of an electrode stack according to an embodiment of the present invention.

FIG. 3A is a perspective view of a shaft according to an embodiment of the present invention.

FIG. 3B is an explosive view of a shaft according to an embodiment of the present invention.

FIG. 3C is an explosive view of a cell core according to an embodiment of the present invention.

FIG. 4A is a schematic diagram of an electrode stack winding on the shaft according to an embodiment of the present invention to form a wound core assembly.

FIG. 4B is a schematic diagram of the top view of a cell core, in which both ties are welded on the wound core assembly of FIG. 4A according to an embodiment of the present invention.

FIG. 4C is a schematic diagram of the bottom view of a cell core, i.e., both ties welded on the wound core assembly of FIG. 4A according to an embodiment of the present invention.

FIG. 4D shows the upper side view of a practical example of a wound core assembly of FIG. 4A according to an embodiment of the present invention.

FIG. 4E shows the upper side view of a practical example of a cell core with a head tie welded on the wound core assembly of FIG. 4A according to an embodiment of the present invention.

FIG. 4F shows a comparative example 2 of a wound core assembly of the Tesla 4680-type cylindrical cells.

FIG. 4G shows a comparative example 3 of a cell core with a welded current collector plate of the Tesla 4680-type cylindrical cells.

FIG. 5 is a flowchart of the method of manufacturing a cell according to an embodiment of the present invention.

### DETAILED DESCRIPTION OF THE INVENTION

In order to provide a clearer understanding of the technical features, objectives, and effects of the present invention, specific embodiments of the invention are described in detail below with reference to the accompanying drawings. The detailed description and technical contents of the present invention are explained in conjunction with the drawings; however, the accompanying drawings are provided for reference and illustration purposes only and are not intended to limit the scope of the present invention.

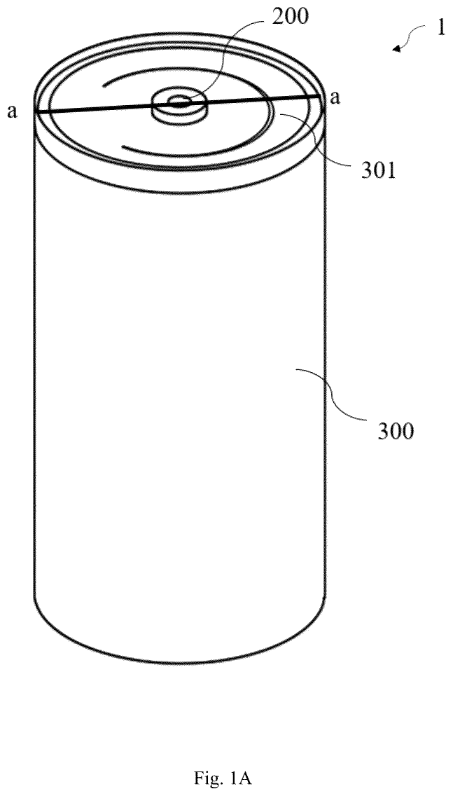

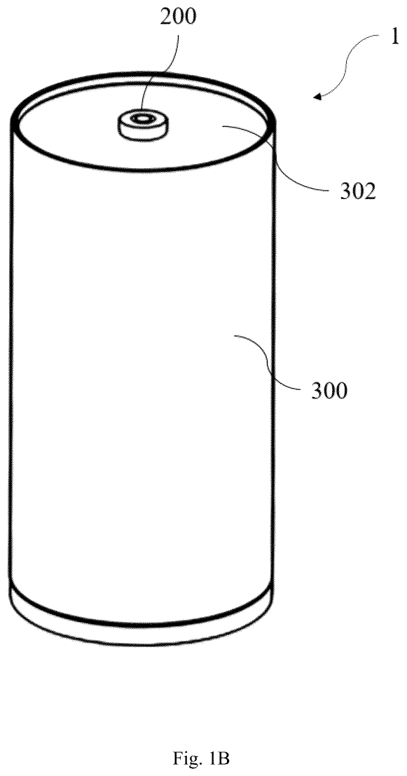

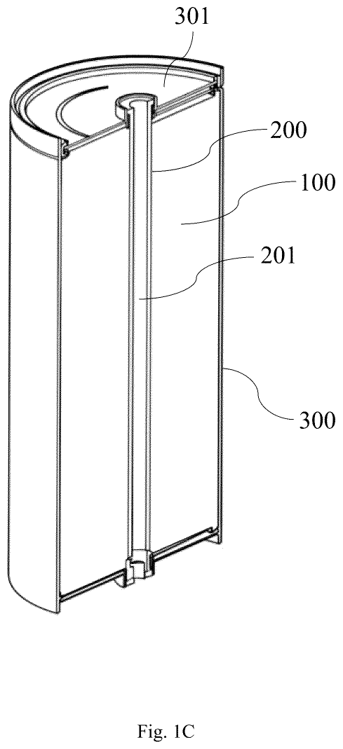

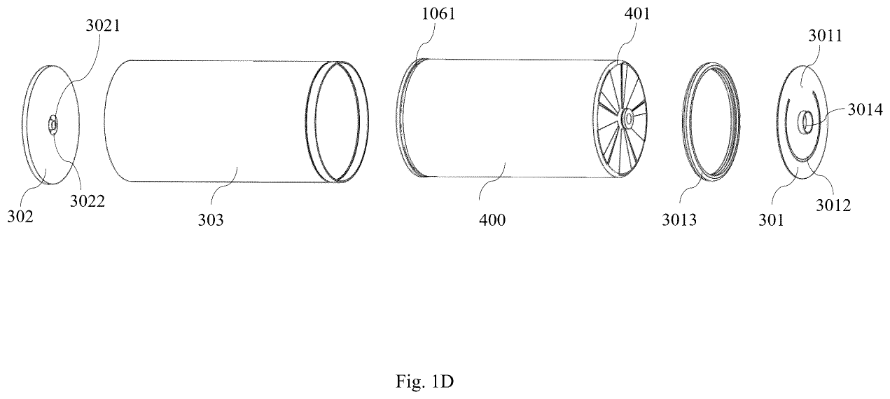

Referring to FIGS. 1A, 1B, 1C, and 1D, FIG. 1A is a schematic diagram of a cell according to an embodiment of the present invention; FIG. 1B is a bottom view of a cell according to an embodiment of the present invention; FIG. 1C is a cross-sectional view taken along the line a-a of FIG. 1A; and FIG. 1D is an explosive view of a cell according to an embodiment of the present invention.

As shown in FIGS. 1A, 1B, 1C, and 1D, the present invention provides a cell 1 of an energy storage device, the cell 1 comprising: an electrode assembly 100, a shaft 200 and an enclosure 300. The cell 1 is a primary or secondary electrochemical cell or an electrophysical cell, including but not limited to such as a lithium-ion battery, a sodium-ion battery, a lithium-metal anode battery, an all-solid-state battery, a metal-air battery, a symmetric supercapacitor, a nonsymmetric supercapacitor, and other types of energy storage devices.

Within the fields of electrochemical and electrophysical cells, the electrode assembly 100 and the shaft 200 together define the inner structure of the cells 1, named as a cell core 400, while the enclosure 300 houses the cell core 400, without losing clearness and accuracy in cell design and manufacturing. Therefore, the cell core 400, except the ends of the shaft 200, is invisible in FIGS. 1A and 1B but it is shown in FIG. 1C. And FIG. 1C demonstrates clearly a conducting channel 201, going through two ends of the shaft 200, which offers a direct convection passway for air or coolant flows according to an embodiment of the present invention.

As shown in FIG. 1D, the enclosure 300 comprising a cover 301, a bottom 302, and a thin-walled shell 303, the enclosure 300 encloses the cell core 400 inside, the cover 301 and the bottom 302 are two opposite external terminals, respectively, and the shaft 200 runs through the electrode assembly 100 and protrudes from the cover 301 and the bottom 302 of the enclosure 300, respectively.

As shown in FIG. 1D, the cover 301, the bottom 302, and the shell 303 of the enclosure 300 are electrically and thermally conductive materials of metal, metal alloy, compounds, metallized plastic composites, or one or a mixture of them. Both cover 301 and bottom 302 of the enclosure 300 comprise an open section, 3014 and 3022, respectively, to allow the two ends of the shaft 200 protrude from, the cover 301 is insulated from the shell 303 of the enclosure by an insulating ring 3013 and is the contact point to the head rim of the shaft 200, the bottom 302 is insulated from the body 201 of the shaft 200 by an insulating sheath 3021 and is the contact point to the tail tie of the shaft 200, wherein the cover 301 encloses the head from outside, the bottom 302 encloses the tail from outside, and the bottom 302 may or may not be insulated from the thin-walled shell 303.

As shown in FIG. 1D, the cover 301 comprises a hole 3011 or no hole 3011, the cover 301 comprises a dent 3012 or no dent 3012, the hole 3011 is resealable for liquid electrolyte injection, degassing in formation, and/or regeneration flushing, and the dent 3012 is a vent design to release gases and pressure. Further, the bottom 302 comprises a hole 3011 or no hole 3011, the bottom 302 comprises a dent 3012 or no dent 3012, the hole 3011 is resealable for liquid electrolyte injection, degassing in formation, and/or regeneration flushing, the dent 3012 is a vent design to release gases and pressure, and the bottom 302 is an undetachable portion of the enclosure 300. The groove 401 and 402 on the head and tail ties of the cell core 400, respectively, allow the liquid electrolyte injection and gases passing.

### Example 1

In a cylindrical cell manufacturing, with a cell core 400, the housing steps shown in FIG. 1D includes:
slipping the insulating ring 3013 on the periphery of cover 301;
pushing the shaft 200 of the cell core 400 through to protrude from the inner open section 3014 of cover 301, which is designed to match the rim edge of the shaft head;
welding the inner portion 3014 of cover 301 with the rim edge by a laser welder;
pushing the covered cell core 400 down through the thin-walled shell 300 to the designed cell height;
clamping the 3013 insulated periphery of cover 301 in the thin-walled shell 303 by a hardware to finish assembling the upper terminal of the cell 1;
slipping the insulating sheath 3021 on the tail part of the shaft 200 of the partially shelled cell core 400;
pushing down bottom 302 to fit in between the inside wall of the shell 303 and the periphery of the insulating sheath 3021 on the tail part of shaft 200, which is designed to match and protrude from the inner open section 3022 of bottom 302;
welding the periphery 1061 of the tail tie of cell core 400 and bottom 302 on the inner wall of the thin-walled shell 303 by a laser welder;
clamping the inner open section 3022 of bottom 302 on the insulating sheath 3021 on the shaft 200 by a hardware to finish the lower terminal of the cell 1 and then complete the housing and sealing of the cell 1.

Note, the assembling order of steps disclosed in Example 1 may be interchangeable among the slipping, welding and clamping without breaking the straight-through pipeline from inner to outer parts. This removes completely the pin-welding method used in the current state-of-the-art cylindrical cell manufacturing. Sealing methods in housing steps such as welding and clamping shown in Example 1 can be changed or replaced by other equivalent manufacturing methods.

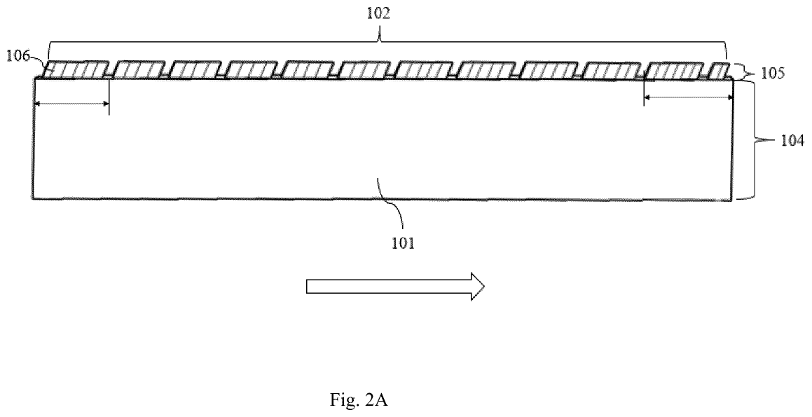

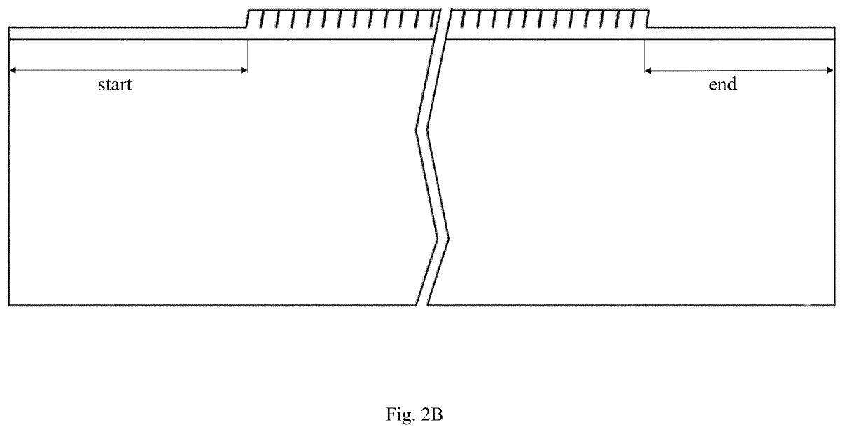

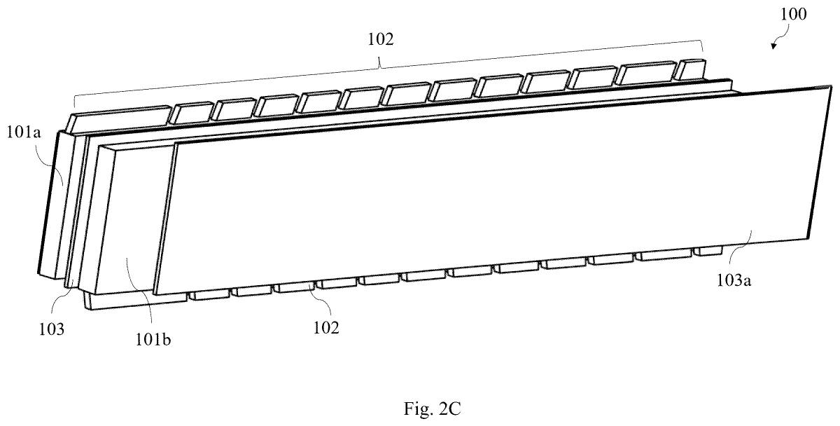

Referring to FIGS. 2A to 2C, FIG. 2A is a schematic diagram of an electrode plate according to an embodiment of the present invention; FIG. 2B shows a comparative example 1 of a practical design of a tabless electrode plate used in the Tesla 4680-type cylindrical cells, as disclosed in Tesla patent application (International Publication Number WO2022/061187A1); and FIG. 2C is a schematic diagram of an electrode stack for assembling a cell core 400 according to an embodiment of the present invention. As shown in FIG. 2A, each electrode plate 101 consists of a current collector comprising an active area 104 overlapping in the electrode assembly 100 and a tab area 105 non-overlapping in the electrode assembly 100. In the tab area 105 of electrode plates 101, the cutting flags 106 are grouped into an intermittent pattern 102 by design from the start to the end of the whole electrode plate 101 in the machine direction. The machine direction is the rolling direction to wind a cell core, as shown by the arrow. The designed intermittent pattern 102 has wider cutting separations between flag groups than those fine separations between cutting flags. After winding, the pattern 102 forms open grooves on both circular faces 401 and 402, respectively, of the cell core 400 across the machine direction shown in FIG. 1D. Furthermore, the active area 104 of the electrode plate 101 is coated with electrode materials composites.

### Example 2

According to an embodiment of the present invention, electrode materials composites consist of battery material that is selected from: lithium metal, Li-M alloys (M=Mg, Ag, Zn, Al, Ga, In, Sn, Sb, and Bi), silicon materials (such as silicon, metallic silicon, silicon-carbon (Si/C) composites, silicon oxide (SiOₓ), lithiated silicon, lithiated Si/C, and lithiated silicon oxide), graphitic materials, graphite, graphene-containing materials, hard carbon, soft carbon, carbon nanotubes, porous carbon, conductive carbon, a lithium titanate, sulfur and sulfurized-carbon (such as sulfurized polyacrylonitrile), a layered transition metal oxide (such as a lithium cobalt oxide, lithium nickel manganese cobalt oxide, a lithium nickel cobalt aluminum oxide, and their derivatives), a lithium-rich transition metal oxide (such as Li₂MnO₃,Li₆CoO₄, Li₅FeO₄, and their derivatives), a spinel-manganese oxide (such as a lithium manganese oxide, LiMn_{1.5}Ni_{0.5}0₄, and their derivatives), an olivine lithium iron phosphate (such as LiFePO₄, LiFeMnPO₄, and their derivatives), lithium chalcogenides (LiTiS₂), lithium tavorite (LiFeSO₄F), lithium transition metal silicates (such as Li₂CoSiO₄, Li₂FeSiO₄, Li₂MnSiO₄, and their derivatives), tin oxide (SnOₓ), manganese oxide (MnOₓ), molybdenum oxide (MoO₂), molybdenum disulfide (MoS₂), nickel oxide (NiOₓ), copper oxide (CuOₓ), and lithium sulfide (Li₂S), lithium halides, air (oxygen), and combinations thereof.

### Example 3

According to an embodiment of the present invention, electrode materials composites consist of battery material that is selected from: sodium metal, carbon-based materials (such as carbon arsenide, expanded graphite, soft-hard carbon, carbon nanomaterials, carbon nanofiber, nitrogen-doped hard carbons, and/or Biomass-derived hard carbon), alloy materials with sodium (such as Si, Ge, Sn, P, Sb, Pb, and Bi), sodium oxides, sodium sulfides, molybdenum disulphide, a rock-salt TiO₂, sodium terephthalate derivatives, sodium titanate, conjugated carboxylate organic compounds, Schiff base polymers, conducting polymers (such as conjugated polymers, polyamides and polyquinones), sodium layered and P2-type transition metal oxides (NaₓMO₂, M=Fe, Ni, Co, Mn, Cu, and others, and 0<x≤1), Na-richer oxides, fluorine-doped metal oxide (such as Na_{0.65}MnO₂₋ₓFₓ), vanadium phosphate and polyanionic compound (NaₓM_{y}(XₐO_{b})_{z}Z_{w}, M=Ti, V, Cr, Mn, Fe, Co, Ni, Ca, Mg, Al, Nb; X=S, P, As, Si, B, Mo, W, Ge; Z=F, OH), NASICON (Na superionic conductor, NaₓM₂(XO₄)₃, M=V, Fe, Ni, Mn, Ti, Cr, Zr; X=P, S, Si, Se, Mo; 1<x≤4), Prussian Blue and analogues PBAs (AₓM₁[M₂(CN)₆]_{y}·zH₂O, M₁/M₂=Ti, Mn, Fe and Co; A=an alkali metal), and combinations thereof.

### Example 4

According to an embodiment of the present invention, electrode materials composites consist of battery material that is selected from: magnesium metal, magnesium intermetallics (such as Mg₃Bi₂ and Mg₂Sn), manganese dioxide and vanadium pentoxide, transition metal chalcogenide (such as TiS₂, CoS₂ and FeS₂), olivine-type MgFeSiO₄, cluster Compounds (such as chevrel phase Mo₆S₈), anthraquinone and organo-polymer materials, metal halide (such as silver chloride, copper chloride, palladium chloride, copper iodide, copper thiocyanate), and combinations thereof.

### Example 5

According to an embodiment of the present invention, electrode materials composites consist of supercapacitor material that is selected from: metal-organic frameworks, carbonaceous materials (include activated carbon, carbon fibre-cloth, carbide-derived carbon, consolidated amorphous carbon, carbon aerogels, carbon nanotubes, graphene, carbon microbeads, carbon fibers, and graphite), metal oxides (such as manganese dioxide, iridium dioxide, and ruthenium dioxide), sulfides (such as titanium sulfide), conductive polymers (such as polyaniline, polythiophene, polypyrrole, polyacene, and polyacetylene), spinel nickel-cobalt oxides, LISICON/NASICON-type materials, lithium active battery materials, sodium active battery materials, conducting polymer, and combinations thereof.

### Comparative Example 1

FIG. 2B shows a practical design of a tabless electrode plate used in the Tesla 4680-type cylindrical cells that shows at the start and end of the electrode plate the flags are cut off due to the space needed for flatting flags in the center and outer rim of the circular faces of the jelly roll. That results in different folding patterns on the circular faces of the core assembly, i.e., jelly roll, comparing to the intermittent pattern 102 of flag groups 106.

As shown in FIG. 2C, the electrode assembly 100 comprises two electrode plates 101 with tabs 102 in opposite directions and a separator 103 interposed between the two plates 101 to form an electrode stack before assembling a cell core. The active areas 104 of both plates 101 are face-to-face overlapping in the stack, while the tab areas 105 are not overlapping in the stack configuration. Note, the fine separation between flags is not shown in FIG. 2C and following drawings to highlight the characteristic pattern 102 and its effects to form grooves on the circular faces of the jelly roll. An additional separator 103a, off-setting from the start of the electrode assembly 100, is added on top of one electrode plate for the purpose to interposing between the two electrodes 101 in successively winding the electrode stack to form a jelly roll. As shown in FIG. 2C, one electrode plate 101 forms an anode 101a, and the other electrode plate forms a cathode 101b.

According to an embodiment of the present invention, the current collector of the two electrode plates 101 comprises the same electrically and thermally conductive materials of metal foil, metal foam, 3-D conductive substrate, plastic electrodes, metallized plastic composites, or one or a mixture of them. In practice, sodium-ion battery cells, symmetric supercapacitors, and other advanced chemistry and physics systems can adopt that kind of electrode design within the cell structure of cell 1.

### Example 6

According to an embodiment of the present invention, two aluminum foils are coated with activated carbon (composited with conductive agent and binder) by the state-of-the-art coating technology and their tabs 105 are cut into the designed pattern 102 shown in FIG. 2A by a laser cutting machine. One serves as anode 101a and the other cathode 101b to fabricate in an electrode stack in the configuration of FIG. 2C for further processing to make a symmetric supercapacitor cell in the cell structure of cell 1, which comprise the same Al foils as the current collectors and identical electrode materials composite (activated carbon). In another embodiment of the present invention, anode 101a is coated with porous carbon composite on an aluminum foil, while cathode101b is coated with Prussian blue analogue composite on an aluminum foil, by the state-of-the-art coating technology. Both tabs 105 of anode 101a and cathode 101b are cut into the designed pattern 102 shown in FIG. 2A by a laser cutting machine and are fabricated in an electrode stack in the configuration of FIG. 2C for further processing to make a sodium-ion battery cell in the cell structure of cell 1, which comprise the same Al foils as the current collectors but coated with different composites, porous carbon as the anode and Prussian blue analogue as the cathode, respectively.

According to an embodiment of the present invention, the current collector of the two electrode plates 101 comprises different electrically and thermally conductive materials of metal foil, metal foam, 3-D conductive substrate, plastic electrodes, metallized plastic composites, or one or a mixture of them.

According to an embodiment of the present invention, the active area 104 of the electrode plate 101 can be laminated with a separator 103 by a hot-pressing process to increase the manufacturing yield and speed.

The anode and cathode comprise different electrode materials composites and coated on different current collectors. In practice, the state-of-the-art manufacturing of lithium-ion battery cells, nonsymmetric supercapacitors, and other advanced chemistry and physics systems can adopt that kind of electrode design and processing to achieve high speed and high yield massive production.

### Example 7

According to an embodiment of the present invention, anode 101a is coated with graphite composite on a copper foil, while cathode101b is coated with transition metal oxide NMC composite on an aluminum foil by the state-of-the-art coating technology. Both tabs 105 of anode 101a and cathode 101b are cut into the designed pattern 102 shown in FIG. 2A by a laser cutting machine and are fabricated in an electrode stack in the configuration of FIG. 2C for further processing to make a lithium-ion battery cell in the cell structure of cell 1, which comprise different foils, Al foils and Cu foils, as the current collectors and coated with different composites, graphite as the anode and NMC as the cathode, respectively. Furthermore, after anode tab cutting, the anode electrode can be stacked and pressed with separators under controlled heat and pressure in a lamination process by an integrated cutting-lamination-winding machine to ensure that the anode electrodes are tightly bonded with separators, reducing the internal resistance and improving the overall efficiency of the battery cell.

Metal foams (such as tin foam, nickel foam and copper foam), carbon foams (such as reticulated vitreous carbon, graphene, carbon fiber, activated carbon, and biomass carbon), polymer foams (such as polyurethane foam, melamine foam, and polystyrene foam), and all those within the general scope of 3-D conductive substrate, provide porous electrodes for energy storage devices. In practice, the state-of-the-art manufacturing of nickel-metal hydride (NiMH) battery cells, nickel-cadmium (NiCd) battery cells, metal-air battery cells, and other advanced chemistry and physics systems can adopt that kind of flag pattern design with foam electrodes.

### Example 8

According to an embodiment of the present invention, cathode 101b is coated with nickel hydroxide (composited with conductive agent and binder) onto a nickel foam by the state-of-the-art coating technology and its tab 105 is cut into the designed pattern 102 shown in FIG. 2A by a laser cutting machine. The said cathode 101b can be fabricated in an electrode stack with corresponding metal hydride alloy anode 101a in the configuration of FIG. 2C for further processing to make a NiMH battery cell in the cell structure of cell 1. In another embodiment of the present invention, cathode101b is sprayed with carbon black (composited with catalysts and binder) onto a nickel foam by the state-of-the-art thermal spraying technology and its tab 105 is cut into the designed pattern 102 shown in FIG. 2A by a laser cutting machine. The said cathode 101b as an air cathode electrode can be fabricated in an electrode stack with corresponding lithium metal anode 101a in the configuration of FIG. 2C for further processing to make a lithium-air battery cell in the cell structure of cell 1. Note, the resealable holes 3011 on cover 301 and/or bottom 302 and the open grooves 401 and 402 on the circular faces of cell core 400 provide the needed air flow channels for metal-air battery cells in general.

According to an embodiment of the present invention, the anode 101a or the cathode 101b comprises current collectors, or metal alloying current collectors, or composited current collectors, or ceramic laminated current collectors, or polymer coating current collectors, or a mixture thereof. In practice, the state-of-the-art manufacturing of lithium metal anode battery cells, sodium metal anode battery cells, a lithium-sulfur battery cell, solid-state battery cells, and other advanced chemistry and physics systems can adopt that kind of flag pattern design on synthesized current collector electrodes.

### Example 9

According to an embodiment of the present invention, anode 101a is a copper foil prelithiated with a thin lithium metal layer by the state-of-the-art calendering technology and cathode 101b is the sulfur cathode. Both tabs 105 of anode 101a and cathode 101b are cut into the designed pattern 102 shown in FIG. 2A by a laser cutting machine and are fabricated in an electrode stack in the configuration of FIG. 2C for further processing to make a lithium-sulfur battery cell in the cell structure of cell 1. In another embodiment of the present invention, the separators 103 and 103a use a solid-state electrolyte and further process to make a solid-state battery cell in the cell structure of cell 1.

Moreover, the separator 103 is made of an electrically insulating ion-conductive medium, and the electrical insulating ionic conducting medium is a solid-state electrolyte, or a polymer electrolyte, or a polymeric ionic liquid electrolyte, or a hybrid electrolyte system; wherein the hybrid electrolyte system is a mixture of solid-state electrolyte with liquid electrolyte or a polymer electrolyte with liquid electrolyte or a polymer film soaked with liquid electrolyte, but the present invention is not limited thereto. In addition, the polymer film is coated with ceramic and salts, the liquid electrolyte is a non-aqueous organic electrolyte or aqueous electrolyte or ionic liquid electrolyte, and the solid-state electrolyte comprises flexible fibers infused with fast ionic conductive solids, but the present invention is not limited thereto.

### Example 10

According to an embodiment of the present invention, the solid-state electrolyte is selected from: oxide inorganic solid electrolytes (such as LISICON, e.g. LGPS, LiSiPS, LiPS; argyrodite-like, e.g. Li₆PS₅X, X=Cl, Br, I; garnets, e.g. LLZO; NASICON, e.g. LTP, LATP, LAGP), lithium nitrides, lithium hydrides (such as LiBH₄), lithium phosphidotrielates, and phoshidotetrelates, perovskites (such as lithium lanthanum titanate), sulfide-based or halide-based inorganic solid electrolytes (such as Li₁₀GeP₂S₁₂, Li₆PS₅X, or halide analogues), glass-ceramic variants (e.g., Li₂S—P₂S₅ systems), polymer electrolytes including PEO, polycarbonates, polyesters, polynitriles, polyalcohols, polyamines, polysiloxane, fluoropolymers, bio-polymers (such as lignin, chitosan and cellulose).

### Example 11

According to an embodiment of the present invention, the polymer film is selected from: polytetrafluoroethylene, nonwoven fibers (such as cotton, nylon, polyesters, glass, nanofiber), polymer films (such as polyethylene, polypropylene, poly (tetrafluoroethylene), polyvinyl chloride), polyolefin, polyurethane, polyamide, nylon or cellophane, polymers with ceramics, woven ceramic fibers, cellulose, glass fiber, and naturally occurring substances (such as rubber, asbestos, wood, parchment paper, thin cotton fabric).

### Example 12

According to an embodiment of the present invention, liquid electrolyte is selected from: lithium salts (such as LiPF₆, LiBF₄, LiFSI, LiTFSI, or LiClO₄) in an organic solvent (such as ethylene carbonate, dimethyl carbonate, diethyl carbonate, and propylene carbonate), cyclic ethers (such as DOL), short-chain ethers (such as DME), glycol ethers (such as DEGDME and TEGDME), acidic electrolytes (such as H₂SO₄ and HCl), alkaline electrolytes (such as KOH, NaOH, and LiOH), neutral electrolytes, ionic liquid electrolyte including imidazolium-based (such as EMIM salts, imidazolium dicyanamide or thiocyanate), pyrrolidinium-based (such as pyrrolidinium bis(trifluoromethylsulfonyl)imide), and phosphonium-based.

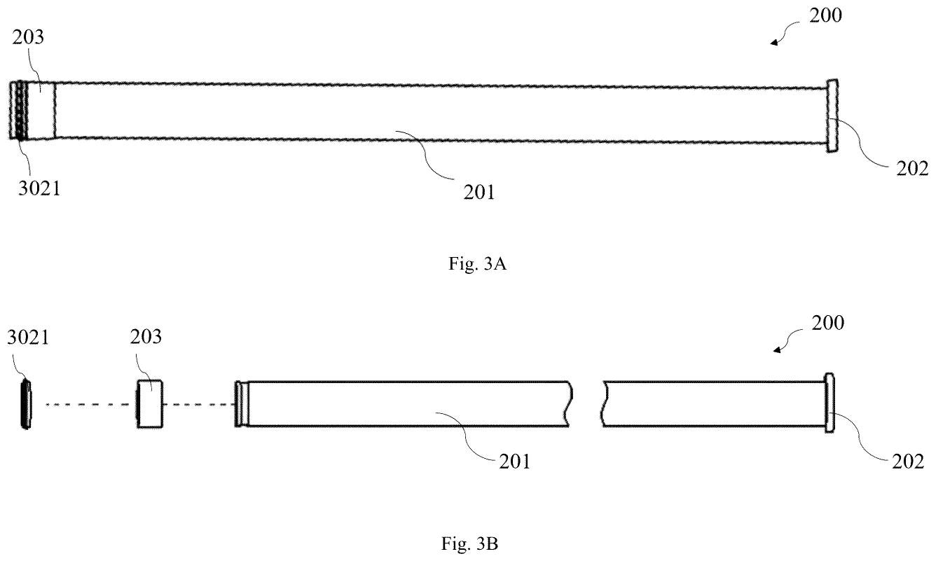

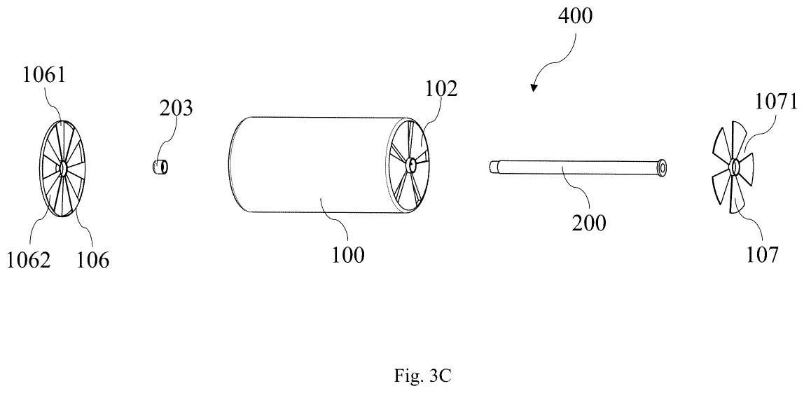

Referring to FIGS. 3A to 3C, FIG. 3A is a perspective view of a shaft according to an embodiment of the present invention; FIG. 3B is an explosive view of a shaft according to an embodiment of the present invention; and FIG. 3C is an explosive view of the cell core 400 according to an embodiment of the present invention.

As shown in FIGS. 3A to 3C, the shaft 200 comprising a body 201, a rim 202 at the head part, and an insulator tube 203 at the tail part, the body 201 supports the electrode assembly 100, the head rim 202 connects cover 301 and one set of tabs 102 of the electrode assembly 100 by a head tie 107, and the tail insulator tube 203 insulates the tail tie 106 and other opposite set of tabs 102 of the electrode assembly 100 from the body 201. The bottom 302 is insulated from the tail end by the insulating sheath 3021 shown in FIG. 1D. More specifically, as shown in FIG. 3C, the head 202 connects one set of tabs 102 of the electrode assembly 100 through a head tie 107, and the other opposite set of tabs 102 of the electrode assembly 100 connects a tail tie 106. The leaf of both ties 106 and 107 match intermittent patterns of flatted flag groups 102 of corresponding tabs on the circular faces of the jelly roll, respectively. While five and seven leaf are shown in FIG. 3C for the head and tail ties, respectively, the practical leaf can be other numbers for both head and tail ties. The space between the leaf also matches the groove formed by the separation of the flag groups 102, providing the liquid and gas flow channels.

As shown in FIGS. 3A and 3B, the body 201 of the shaft 200 consists of a solid bar comprising electrically and thermally conductive materials of metal, metal alloy, compounds, metallized plastic composites, or one or a mixture of them, the bar is in any shape selected from a group consisting of circular, triangular, square, elliptical and rectangular shapes, and the bar conducts electrical current and heat flow from one end to the other end of the shaft 200. Further, the body 201 of the shaft 200 consists of a tube comprising electrically and thermally conductive materials of metal, metal alloy, compounds, metallized plastic composites, or one or a mixture of them, the cross section of the tube is in any shape selected from a group consisting of circular, triangular, square, elliptical and rectangular shapes, the tube conducts electrical current and liquids or gaseous flows from one end to the other end of the shaft, and the wall of the tube may or may not contain an inward dent design to vent gases.

In addition, the body 201 of the shaft 200 includes at least one channel or groove along its length to facilitate the flow of liquid or gas, or to provide a pathway for a sensor or a thermal management element.

Further, the head part of the shaft 200 consists of a rim 202 on one end of the body 201 and a tie connected with one folded tab of one electrode plate 101, the rim is a protrusion of the body 201, the tie is the contact point to the tab of one electrode plate 101, one end of the body 201 may protrude from the rim, and the rim and the tie are electrically and thermally conductive materials of metal, metal alloy, compounds, metallized plastic composites, or one or a mixture of them, the present invention is not limited thereto.

In addition, the tail part of the shaft 200 consists of an insulating tube 203 on the other end of the body 201 and a tie connected with the folded tab of the other electrode plate 101, the tube insulates the tie from the body 201, the other end of the body 201 may protrude from the tail 203, and the tie is an electrically and thermally conductive material of metal, metal alloy, compounds, metallized plastic composites, or one or a mixture of them, the present invention is not limited thereto. Note, the tail tie 106 has a periphery 1061 for welding on the shell 303.

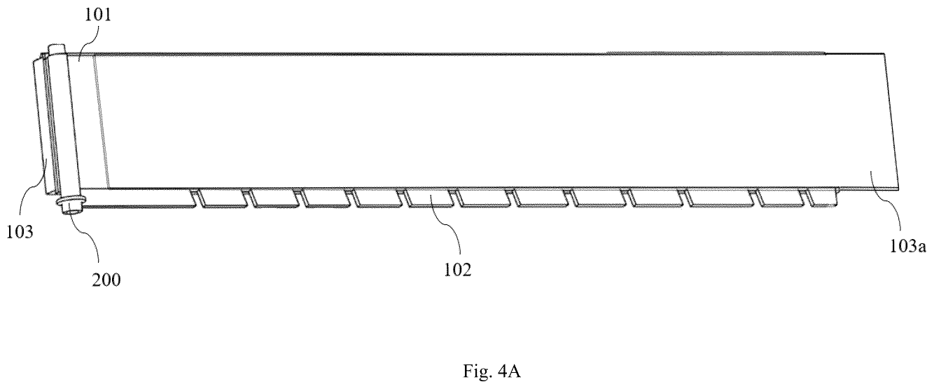

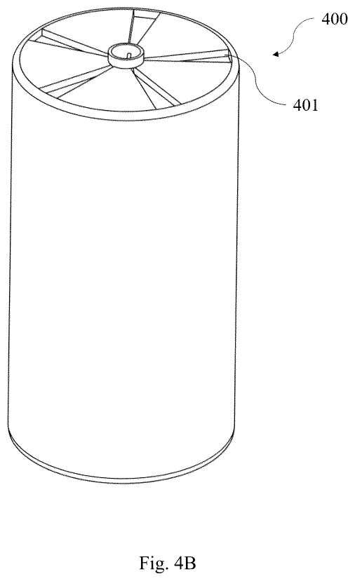

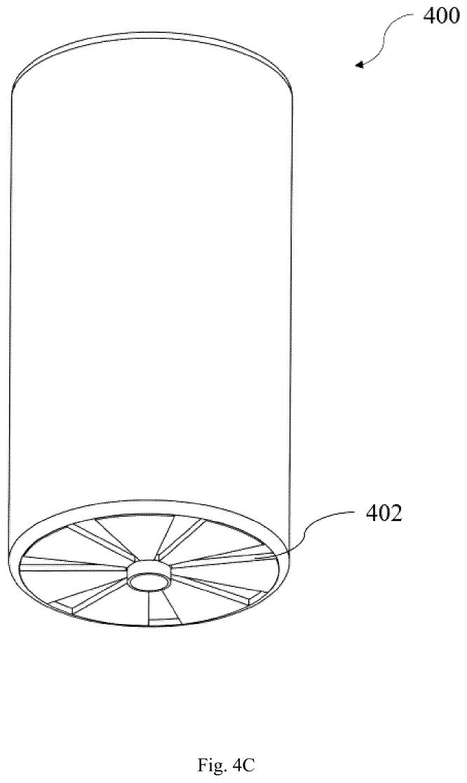

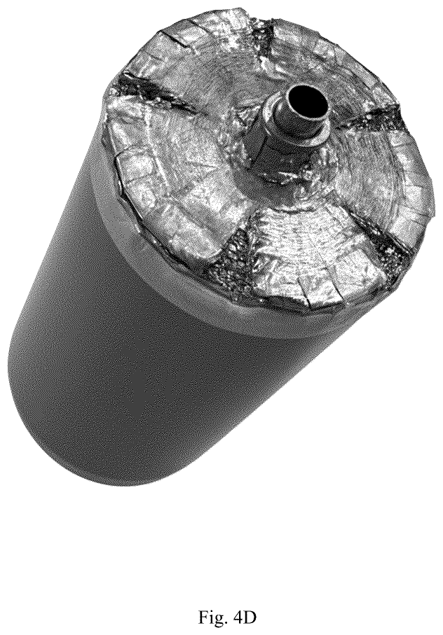

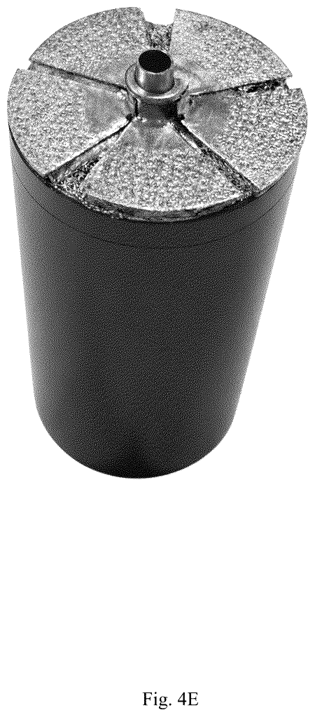

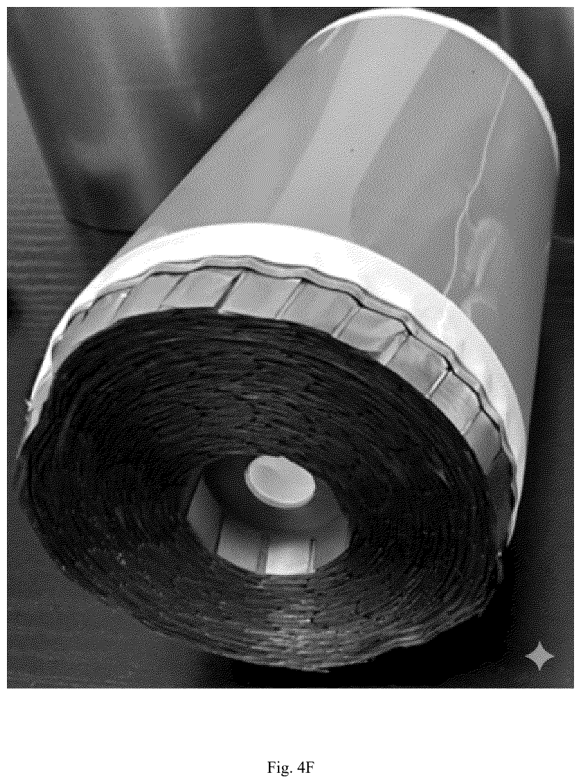

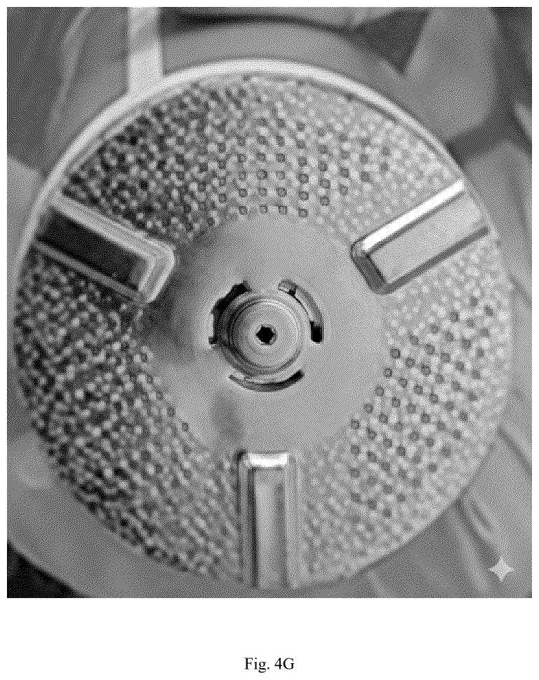

Referring to FIG. 4A to 4E, FIG. 4A is a schematic diagram of the core assembly of an electrode stack winding on the shaft according to an embodiment of the present invention. FIG. 4B is a schematic diagram of the top view of a cell core 400, i.e., both ties welded on the core assembly of FIG. 4A according to an embodiment of the present invention. FIG. 4C is a schematic diagram of the bottom view of a cell core 400, i.e., both ties welded on the core assembly of FIG. 4A according to an embodiment of the present invention. FIG. 4D shows the upper side view of a practical example of a wound core assembly of FIG. 4A according to an embodiment of the present invention. FIG. 4E shows the upper side view of a practical example of FIG. 4B, a cell core with a head tie welded on the wound core assembly of FIG. 4D according to an embodiment of the present invention. FIG. 4F shows a comparative example 2 of a wound core assembly of the Tesla 4680-type cylindrical cells. FIG. 4G shows a comparative example 3 of a cell core with a welded current collector plate of the Tesla 4680-type cylindrical cells.

### Example 13

In a cylindrical cell manufacturing, providing with an electrode stack and a shaft, the assembling steps of a cell core 400, c.f. FIG. 3C includes:
slipping the insulator 203 on the tail of the shaft body 201;
laying out the electrode stack around the shaft body as shown in FIG. 4A;
winding the electrode stack around the shaft body to form a jelly roll;
flatting the flag groups 102 from outer to center of the circular face of the jelly roll with the center portion of flag groups closely wrapping on the body on the head and tail parts. On the head, the inner flag groups are wrapped under the head rim 202, while at the tail, the inner flag groups are wrapped on the insulating tube 203. The rest outer flag groups are flatted on the circular faces of the jelly roll to form grooves, c.f. FIG. 4D;
matching and welding the head tie 107 on the flag pattern on the circular face at the head part by a laser welder, c.f. FIG. 4E;
matching and welding the tail tie 106 on the flag pattern on the circular face at the tail part by a laser welder to finish the assembling a cell core 400.

As shown in FIG. 4A, the description of FIG. 4A to the “unwound” state of the cell core 400, indicates that the core electrochemical or electrophysical component, the electrode assembly 100, consists of flat, long strips of material ready to be layered and subsequently wound.

The “unwound” state means that the core electrochemical or electrophysical components of the cell core 400 are still flat, elongated sheets prepared for stacking and subsequent winding. The electrode plates 101 are long, flat strips of metal foil coated with active material (e.g. typically aluminum foil for the cathode and copper foil for the anode for lithium-ion battery). Before winding, they are flat strips, often staggered or offset from each other. The separator 103 is an insulating thin film interposed between the electrode plates. Its function is to prevent direct contact between the electrodes, which would cause a short circuit, while allowing lithium ions to pass through during charging and discharging. It is also a long, flat sheet. Tabs 102 are the conductive portions extending from the electrode plates 101. In the flat state, they protrude from the edges of the electrodes. After winding is complete, they are gathered and welded to the positive and negative terminals on the battery top, serving as the path for current extraction. In short, the electrode assembly 100 in its unwound state is a stack of these sheets (positive electrode, separator, negative electrode, separator) layered sequentially, ready to form a long, flat “sandwich” structure.

Furthermore, in cylindrical or wound cells, this shaft 200 typically plays triple roles. It serves as the starting point for tightly winding the flat electrode assembly 100 into a compact cylinder or flattened jelly roll. After winding is complete, the shaft remains in the center of the cell as structural support, and sometimes it may integrate pressure relief or safety mechanisms. After housing and sealing, the shaft provides a convective flow channel to convey the heat from the hottest center directly to the outer heat control system. The traditional cell structure, i.e., used in cylindrical, prismatic, or pouch cells, does not have this characteristic functionality.

FIG. 4B and FIG. 4C show the flag groups are closely wrapped around the body 201 at the head part, while at the tail part, the flag groups are closely wrapped on the insulator 203. The extended outer flag groups are flatted to form tabs patterns that contain multiple grooves of the folded tabs due to the intermittent pattern of grouped flags 102 shown in FIG. 2A. The open grooves benefit injections of the liquid electrolyte and gassing.

### Example 14

Following the assembling steps disclosed in example 13, a cell core is assembled with an electrode stack comprising a graphite anode on Cu foil, a NMC cathode on Al foil and Celgard separators, and a shaft comprising an aluminum tube as the body. The head tie is made of aluminum plate, while the tail tie is made of a Ni-plated Cu plate. FIG. 4D shows a photo, an upper side view, of a practical wound core assembly from the electrode stack of FIG. 4A according to an embodiment of the present invention. FIG. 4E shows a photo, an upper side view of a practical cell core 400 with an Al head tie welded on the wound core assembly of FIG. 4D according to an embodiment of the present invention.

On the other hand, without the shaft and the flag pattern 102, the traditional assembling of cylindrical cells results in completely different cell structures as shown in comparative examples 2 and 3. Comparative example 2 shows the full coverage of the flatted flags on the wound cell core and a flagless hollow in the center. In the traditional design and manufacturing of cylindrical cells, the design of cap often blocks the inner center of cells shown in comparative example 3.

### Comparative Example 2

FIG. 4F shows a practical wound electrode stack of the Tesla 4680-type cylindrical cells that shows a hollow center due to the space needed for the tab folding. The anode and cathode coating and separators are the same as used in Example 14 but their tabs use the practical design of FIG. 2B.

### Comparative Example 3

FIG. 4G shows a practical block in the center cap due to a welded Al current collector plate in the design of the Tesla 4680-type cylindrical cells following comparative example 2.

In addition, the enclosure 300 is an external container of the battery cell. It is used to house the completed, wound electrode assembly 100 and the shaft 200, and to provide a sealed environment to prevent electrolyte leakage and external contamination.

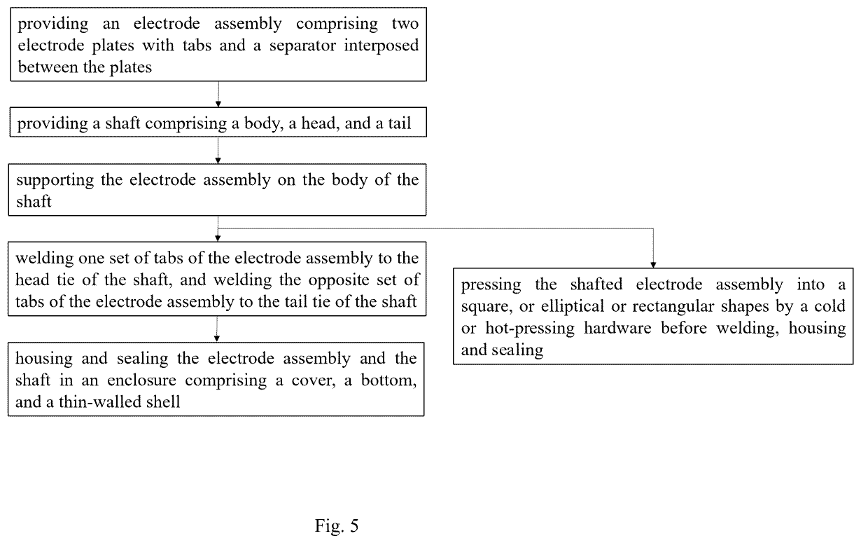

Referring to FIG. 5, FIG. 5 is a flowchart of the method of manufacturing a cell according to an embodiment of the present invention.

As shown in FIG. 5, a method of manufacturing a cell of an energy storage device, the method comprising: providing an electrode assembly comprising two electrode plates with tabs and a separator interposed between the plates; providing a shaft comprising a body, a head, and a tail; supporting the electrode assembly on the body of the shaft; welding one set of tabs of the electrode assembly to the head tie of the shaft, and welding the opposite set of tabs of the electrode assembly to the tail tie of the shaft; enclosing the electrode assembly and the shaft in an enclosure comprising a cover, a bottom, and a thin-walled shell; wherein the enclosure encloses the electrode assembly inside, the cover and the bottom form two opposite external terminals, and the shaft protrudes from the cover and the bottom, and the head and the tail connect with the cover and the bottom, respectively.

The method further comprises pressing the shafted electrode assembly into a square, or elliptical or rectangular shapes by a cold or hot-pressing hardware before enclosing.

The invention is not limited to the specific details, representative embodiments, and examples described herein. Those skilled in the art will recognize that various modifications and other advantages can be achieved without departing from the spirit and scope of the claims and the general concept defined.

What is claimed is:

1. A cell structure of an energy storage device, the cell comprising:
an electrode assembly comprising two electrode plates with tabs and a separator interposed between the plates; and
a shaft comprising a body, a head, and a tail, the body supports the electrode assembly, the head connects one set of tabs of the electrode assembly, and the tail connects the other opposite set of tabs of the electrode assembly; and
an enclosure comprising a cover, a bottom, and a thin-walled shell, the enclosure encloses the electrode assembly inside, the cover and the bottom are two opposite external terminals, respectively, and the shaft runs through the electrode assembly and protrudes from the cover and the bottom of the enclosure, and the head and the tail connect with the cover and the bottom, respectively.

2. The cell structure according to claim 1, wherein each electrode plate consists of a current collector comprising an active area overlapping in the electrode assembly and a tab area non-overlapping in the electrode assembly, the tab comprises an intermittent pattern in the machine direction, and one electrode plate forms an anode, and the other electrode plate forms a cathode.

3. The cell structure according to claim 1, wherein the separator is made of an electrically insulating ion-conductive medium, and the electrical insulating ionic conducting medium is a solid-state electrolyte, or a polymer electrolyte, or a polymeric ionic liquid electrolyte, or a hybrid electrolyte system.

4. The cell structure according to claim 3, wherein the hybrid electrolyte system is a mixture of solid-state electrolyte with liquid electrolyte or a polymer electrolyte with liquid electrolyte or a polymer film soaked with liquid electrolyte.

5. The cell structure according to claim 4, wherein the polymer film is coated with ceramic and salts, the liquid electrolyte is a non-aqueous organic electrolyte or aqueous electrolyte or ionic liquid electrolyte, and the solid-state electrolyte comprises flexible fibers infused with fast ionic conductive solids.

6. The cell structure according to claim 1, wherein the body of the shaft consists of a solid bar comprising electrically and thermally conductive materials of metal, metal alloy, compounds, metallized plastic composites, or one or a mixture of them, the bar is in any shape selected from a group consisting of circular, triangular, square, elliptical and rectangular shapes, and the bar conducts electrical current and heat flow from one end to the other end of the shaft.

7. The cell structure according to claim 1, wherein the body of the shaft consists of a conducting tube comprising electrically and thermally conductive materials of metal, metal alloy, compounds, metallized plastic composites, or one or a mixture of them, the cross section of the conducting tube is in any shape selected from a group consisting of circular, triangular, square, elliptical and rectangular shapes, the conducting tube conducts electrical current and liquids or gaseous flows from one end to the other end of the shaft, and the inner wall of the conducting tube may or may not contain an inward dent design to vent gases in case of thermal runaway or explosion.

8. The cell structure according to claim 1, wherein the head of the shaft consists of a rim on one end of the body and a tie connected with one folded tab of one electrode plate, the rim is a protrusion of the body, the tie is the contact point to the tab of one electrode plate, one end of the body may protrude from the rim, and the rim and the tie are electrically and thermally conductive materials of metal, metal alloy, compounds, metallized plastic composites, or one or a mixture of them.

9. The cell structure according to claim 1, wherein the tail of the shaft consists of an insulating tube on the other end of the body and a tie connected with the folded tab of the other electrode plate, the tube insulates the tie from the body, the other end of the body may protrude from the tail, and the tie is an electrically and thermally conductive material of metal, metal alloy, compounds, metallized plastic composites, or one or a mixture of them.

10. The cell structure according to claim 1, wherein the cover, the bottom, and the thin-walled shell of the enclosure are electrically and thermally conductive materials of metal, metal alloy, compounds, metallized plastic composites, or one or a mixture of them.

11. The cell structure according to claim 10, wherein the cover and the bottom of the enclosure comprise an open section to allow the ends of the shaft protrude through, the cover encloses the shaft head from outside; the bottom encloses the shaft tail from outside, the cover is insulated from the thin-walled shell of the enclosure and is the contact point to the head rim and tie of the shaft, and with the shaft body serving as one terminal of the finished cell; the bottom is insulated from the body of the shaft and is the contact point to the tail tie of the shaft, serving as the other terminal of the finished cell, and the bottom may or may not be insulated from the thin-walled shell.

12. The cell structure according to claim 1, wherein the cover comprises a hole or no hole, the cover comprises a dent or no dent, the hole is resealable for liquid electrolyte injection, degassing in formation, and/or regeneration flushing, and the dent is a vent design to release gases and pressure in case of thermal runaway or explosion.

13. The cell structure according to claim 1, wherein the bottom comprises a hole or no hole, the bottom comprises a dent or no dent, the hole is resealable for liquid electrolyte injection, degassing in formation, and/or regeneration flushing, the dent is a vent design to release gases and pressure in case of thermal runaway or explosion, and the bottom is an undetachable portion of the enclosure.

14. The cell structure according to claim 2, the current collector of the two electrode plates comprises the same or different electrically and thermally conductive materials selected from the group consisting of metal foil, metal foam, 3-D conductive substrate, plastic electrodes, metallized plastic composites, or one or a mixture of them.

15. The cell structure according to claim 2, wherein the active area of the electrode plate is coated with electrode materials composites, the active area of the electrode plate is laminated with a separator, the anode and the cathode comprise the same electrode materials composite, the anode and the cathode comprise different electrode materials composites.

16. The cell structure according to claim 2, wherein the anode or the cathode comprises current collectors, or metal alloying current collectors, or composited current collectors, or ceramic laminated current collectors, or polymer coating current collectors, or a mixture thereof.

17. The cell structure according to claim 1, wherein the cell is a primary or secondary electrochemical cell, and/or an electrophysical cell, including such as a lithium-ion battery, a sodium-ion battery, a lithium-metal anode battery, an all-solid-state battery, a metal-air battery, a symmetric supercapacitor, a nonsymmetric supercapacitor, and other advanced energy storage devices.

18. The cell structure according to claim 1, wherein the body of the shaft includes at least one channel or groove along its length to facilitate the flow of liquid or gas, or to provide a pathway for a sensor or a thermal management element.

19. A method of manufacturing a cell structure of an energy storage device, the method comprising:
providing an electrode assembly comprising two electrode plates with tabs and a separator interposed between the plates;
providing a shaft comprising a body, a head, and a tail;
supporting the electrode assembly on the body of the shaft;
connecting one set of tabs of the electrode assembly to the head of the shaft, and connecting the opposite set of tabs of the electrode assembly to the tail of the shaft;
enclosing the electrode assembly and the shaft in an enclosure comprising a cover, a bottom, and a thin-walled shell;
wherein the enclosure encloses the electrode assembly inside, the cover and the bottom form two opposite external terminals, and the shaft protrudes from the cover and the bottom, and the head and the tail connect with the cover and the bottom, respectively.

20. The method of claim 19, further comprising pressing the shafted electrode assembly into a square, or elliptical or rectangular shapes by a cold or hot-pressing hardware before enclosing.
